(19) United States
(12) Patent Application Publication
(10) Pub. No.: US 2007/0087610 A1
(43) Pub. Date: Apr. 19, 2007

(54) Screen assembling structure

(76) Inventor: Jhen-Siang Wei Siao, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/248,417

(22) Filed: Oct. 13, 2005

(51) Int. Cl. H01R 13/62

(52) U.S. Cl. 439/326

(57) ABSTRACT

A screen includes a panel, a connecting post, and a pair of securing members fastening the panel to the connecting post; the panel has through holes near to an edge thereof; the connecting post has a receiving trench longitudinally extending along each side thereof; one of the securing members has several male connecting parts thereon, and a folded insertion portion at one end thereof; the other securing member has several female connecting parts thereon, and a folded insertion portion at one end thereof; the securing members are tightly pressed against two sides of the panel, and firmly held in position by the connecting post with the male and the female connecting parts being passed through the through holes and coupled, and with the folded insertion portions thereof being detained in one of the receiving trenches and pressed against the connecting post.

### BACKGROUND OF THE INVENTION

1. Field of the Invention

The present invention relates to a screen assembling structure, more particularly one, which will result in reduction in the cost of manufacturing and the amount of labor and time used in assembly.

2. Brief Description of the Prior Art

Screens can be used to divide a room into several sections without making the room feel constricting at the same time.

A conventional screen assembling structure includes a connecting post, and several panels, and several connecting members; the connecting post has a longitudinally extending slide trench along each side thereof; the connecting members each have a step-shaped base tightly held in one longitudinally extending slide trench of the connecting post, and they each have several hollow protrusions, and through holes; the panels each have through holes, into which the hollow protrusions of the connecting members are passed; the panels each have screw holes, and bolts are passed through the through holes of the connecting members, the screw holes, and nuts. Thus, the panels are securely joined to the connecting post.

The above screen assembling structure is relatively complicated, and it will result in significant increase in the manufacturing cost and the amount of labor and time used in assembly. Therefore, such assembling structure isn't economical.

### SUMMARY OF THE INVENTION

It is a main object of the present invention to provide an improvement on a screen assembling structure to overcome the above problems. The screen assembling structure of the present invention includes a panel, a connecting post, and a pair of securing members fastening the panel to the connecting post. The panel has through holes near to an edge thereof while the connecting post has a receiving trench longitudinally extending along each side thereof. One of the securing members has several male connecting parts thereon, and a folded insertion portion at one end thereof while the other securing member has several female connecting parts thereon, and a folded insertion portion at one end thereof. The two securing members are tightly pressed against two sides of the panel, and firmly held in position by the connecting post with the male and the female connecting parts being passed through the through holes and coupled, and with the folded insertion portions thereof being detained in one of the receiving trenches and pressed against the connecting post.

### BRIEF DESCRIPTION OF THE DRAWINGS

The present invention will be better understood by referring to the accompanying drawings, wherein:

FIG. 1 is an exploded perspective view of the first preferred embodiment of a screen assembling structure in the invention, FIG. 2 is a horizontal section of the first embodiment in assembly, FIG. 3 is a horizontal sectional view of the first embodiment, FIG. 4 is a horizontal sectional view of the second embodiment, FIG. 5 is a horizontal sectional view of the third embodiment, and FIG. 6 is a horizontal sectional view of the fourth embodiment.

### DETAILED DESCRIPTION OF THE PREFERRED EMBODIMENTS

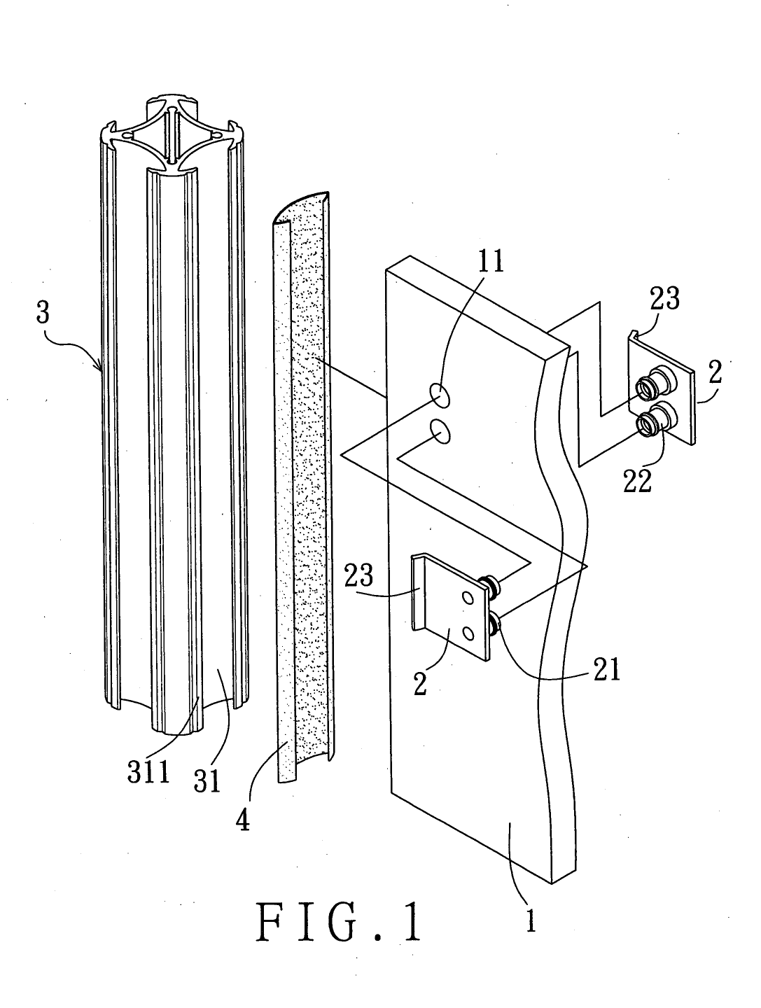

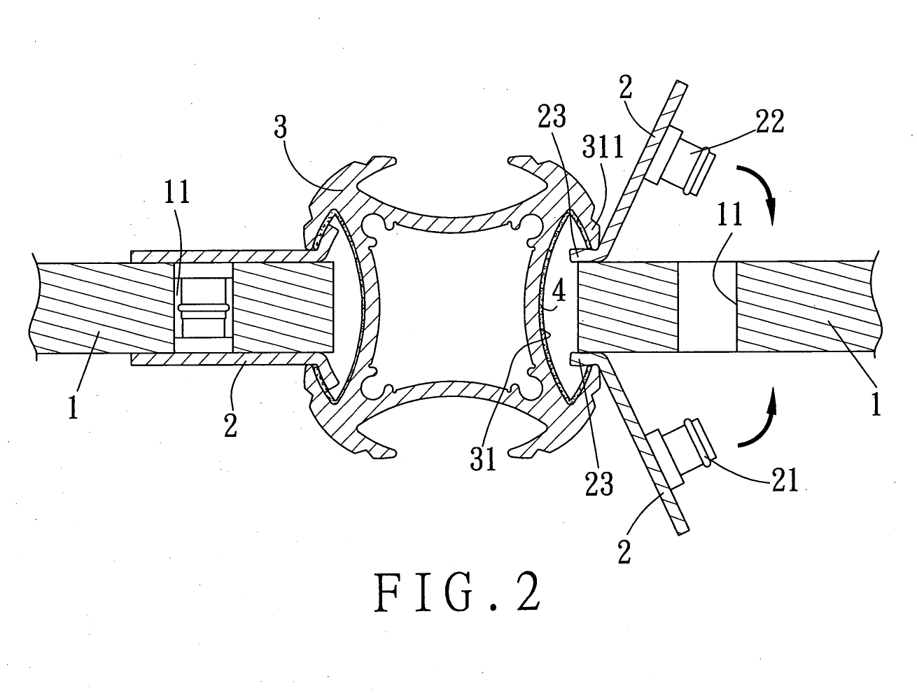

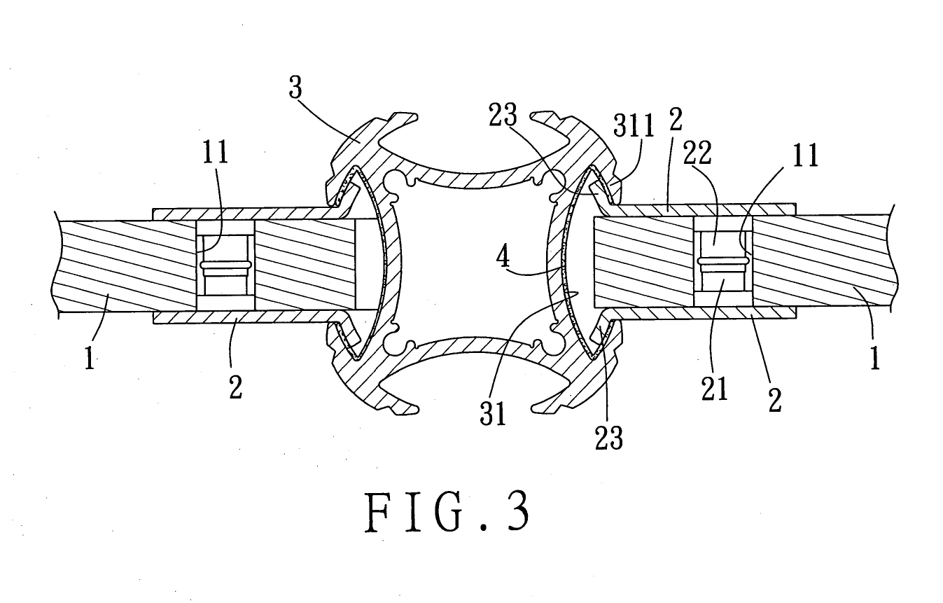

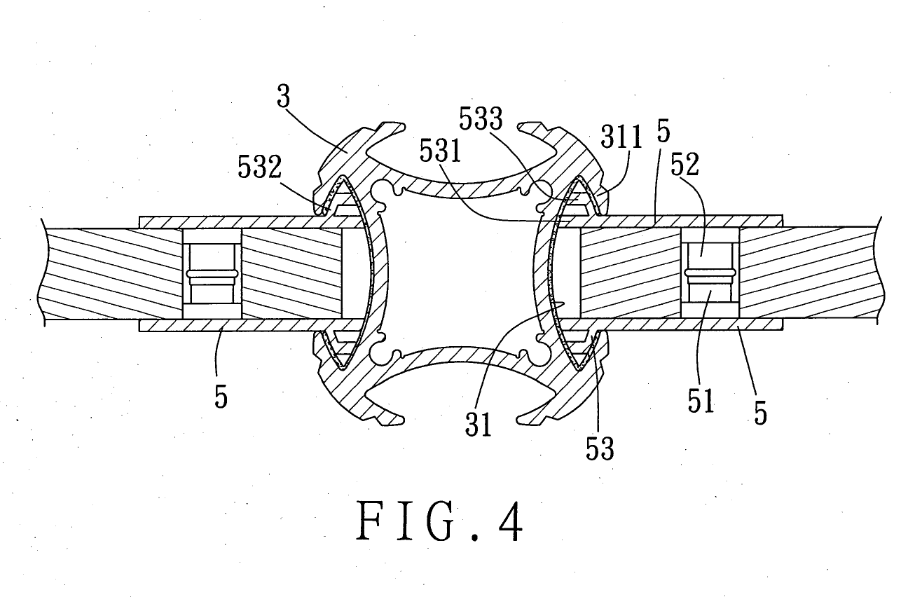

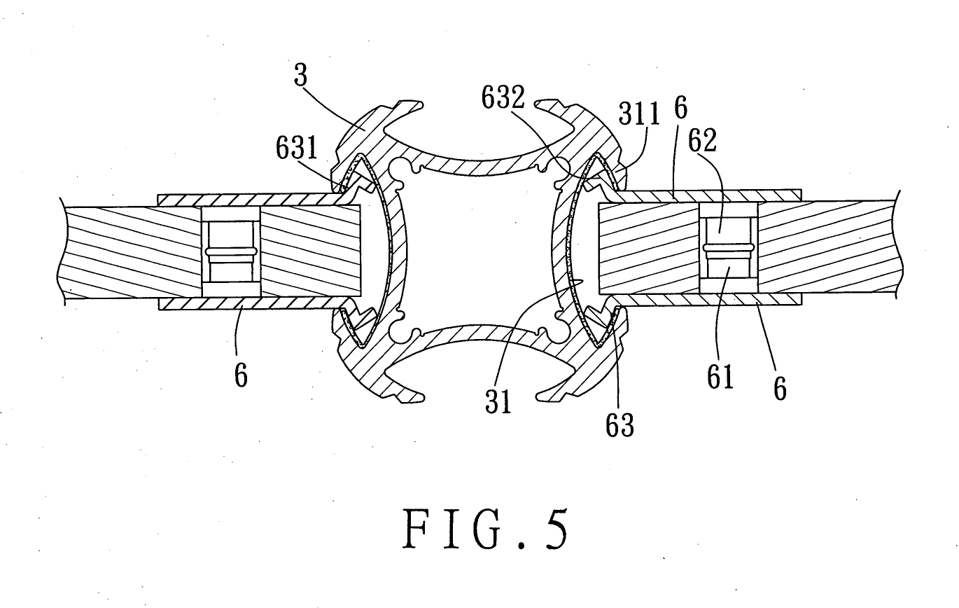

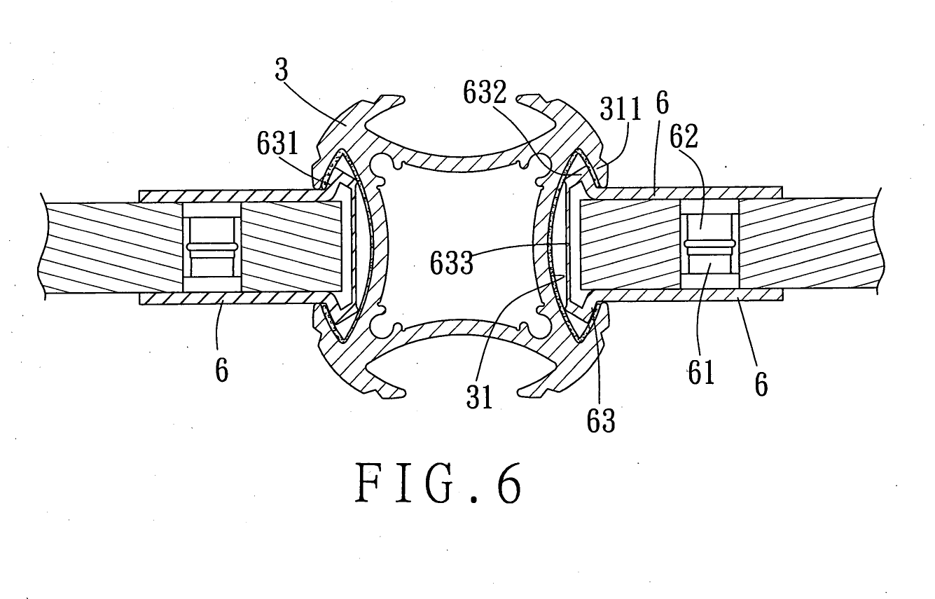

Referring to FIG. 1, a first preferred embodiment of a screen assembling structure of the present invention includes a panel 1, a pair of securing members 2, a connecting post 3, and a soft pad 4.

The panel 1 has two through holes 11 near to an edge thereof. One of the securing members 2 has a substantially folded-plate shape, two male connecting parts 21 thereon, and an outwards-folded insertion portion 23 at one end thereof while the other securing member 2 has a substantially folded-plate shape, two female connecting parts 22 thereon, and an outwards-folded insertion portion 23 at one end thereof.

The connecting post 3 has a receiving trench 31 longitudinally extending along each side thereof, and two longitudinally extending stopping protrusions 311 over two longitudinal edge sections of each of the receiving trenches 31 thereof. The soft pad 4 is closely fitted in one of the receiving trenches 31 of the connecting post 3, and it can be made of rubber so as to have loosening-prevention and slip prevention function.

Referring to FIG. 2, in assembly, first the two securing members 2 are inserted into one of the receiving trenches 31 of the connecting post 3 at the insertion portions 23 thereof with the insertion portions 23 being pressed against respective ones of the longitudinal edges of the stopping protrusions 311. And, the panel 1 is inserted between the securing members 2 such that the through holes 11 thereof face the male and the female connecting parts 21 and 22. Next, the securing members 2 are pressed towards each other such that the male and the female connecting parts 21 and 22 are passed through the through holes 11 and coupled. Therefore, the panel 1 is tightly pressed between the two securing members 2, and the insertion portions 23 of the securing members 2 are held in the receiving trench 31, pressed against the inner sides of the longitudinal stopping protrusions 311 of the connecting post 3, and stopped from moving outside, as shown in FIG. 3. Consequently, the panel 1 is securely joined to the connecting post 3 with the help of the securing members 2. In addition, the soft pad 4 will prevent the securing members 2 from sliding.

Referring to FIG. 4, a second preferred embodiment of a screen assembling structure of the present invention includes a pair of securing members 5 instead of the securing members 2 of the first embodiment. One of the securing members 5 has a substantially folded-plate shape, two male connecting parts 51 thereon, and an insertion portion 53 at one end thereof, which is held in the receiving trench 31 of the connecting post 3. The other securing member 5 has a substantially folded-plate shape, two female connecting parts 52 thereon, and an insertion portion 53 at one end thereof, which is held in the receiving trench 31 of the connecting post 3. Furthermore, each of the insertion portions 53 has a first pressing portion 531, which projects from and extends in a parallel relation with a main body of the securing member 5, and which is pressed against an outwards facing side of the connecting post 3 that defines the receiving trench 31. Each of the insertion portions 53 has a sideways-projecting touching portion 532, which is pressed against an inward side of the corresponding longitudinal stopping protrusion 311 of the connecting post 3. And, each of the insertion portions 53 has a second pressing portion 533, which projects from and extends in a substantially perpendicular relation with the touching portion 532, and which is pressed against an outwards facing side of the connecting post 3 that defines the receiving trench 31. Thus, the panel 1 is firmly secured by the securing members 5.

Referring to FIG. 5, a third preferred embodiment of the present invention includes a pair of securing members 6 instead of the ones 2 and 5. One of the securing members 6 has a substantially folded-plate shape, two male connecting parts 61 thereon, and an insertion portion 63 at one end. The other securing member 6 has a substantially folded-plate shape, two female connecting parts 62 thereon, and an insertion portion 63 at one end thereof. Each of the insertion portions 63 has an outwards folded touching portion 631, which is pressed against an inward side of the corresponding longitudinal stopping protrusion 311 of the connecting post 3. Furthermore, each of the insertion portions 63 has an inwards folded pressing portion 632 at a tail end thereof, which abuts the outwards folded touching portion 631, and which is pressed against an outwards facing side of the connecting post 3 that defines the receiving trench 31. Therefore, the panel 1 is firmly secured by the securing members 6.

Referring to FIG. 6, in a fourth preferred embodiment of the present invention, an elastic plate 633 is joined to the opposed sides of the tail ends of the pressing portions 632 of the two securing members 6 at two ends thereof; the elastic plate 633 will be in a curved shape when the securing members 6 are inserted in the receiving trench 31 of the connecting post 3, and pivoted away from each other for allowing the panel 1 to be inserted between them in assembly; the elastic plate 633 will return to its original shape as soon as the securing members 6 are joined together at the male and the female connecting parts 61 and 62; after assembly, the touching portions 631 of the insertion portions 63 will be pressed against inner sides of the stopping protrusions 311 of the connecting post 3 while the pressing portions 632 will be pressed against an outwards facing side of the connecting post 3 that defines the receiving trench 31.

From the above description, it can be easily seen that the screen assembling structure of the present invention can result in reduction in the number of connecting parts and elements used in assembly, the manufacturing cost and the amount of time and labor used in assembly. In other words, the assembling structure of the present invention is more economical than the conventional ones.

What is claimed is:

1. A screen assembling structure, comprising
a panel; the panel having a plurality of through holes near to an edge thereof;
a connecting post having a receiving trench longitudinally extending along each side thereof; and
a pair of securing members fastening the panel to the connecting post; one of the securing members having a plurality of male connecting parts thereon, and a folded insertion portion at one end thereof; other one of the securing members having a plurality of female connecting parts thereon, and a folded insertion portion at one end thereof; the securing members being tightly pressed against two sides of the panel with the male and the female connecting parts being passed through the through holes and coupled; the securing members being firmly held in position by the connecting post with the folded insertion portions being held in one of the receiving trenches and pressed against the connecting post.

2. The screen assembling structure as claimed in claim 1, wherein each of the insertion portions of the securing members has a first pressing portion, which projects from and extends in a parallel relation with a main body of the securing member, and which is pressed against an outwards facing side of the connecting post that defines the receiving trench; each of the insertion portions has a sideways-projecting touching portion, which is pressed against an inward side of the connecting post that defines the receiving trench; each of the insertion portions has a second pressing portion, which projects from the sideways-projecting touching portion.

3. The screen assembling structure as claimed in claim 1, wherein each of the insertion portions of the securing members has an outwards folded touching portion, which is pressed against an inward side of the connecting post that defines the receiving trench; each of the insertion portions has an inwards folded pressing portion at a tail end thereof, which abuts the outwards folded touching portion, and which is pressed against an outwards facing side of the connecting post.

4. The screen assembling structure as claimed in claim 3, wherein an elastic plate is joined to tail ends of the insertion portions of the two securing members at two ends thereof.

5. The screen assembling structure as claimed in claim 1, wherein each of the receiving trenches of the connecting post has a soft pad closely fitted therein.

6. The screen assembling structure as claimed in claim 5, wherein the soft pad is made of rubber.
